(19) United States
(12) Patent Application Publication
(10) Pub. No.: US 2009/0186633 A1
(43) Pub. Date: Jul. 23, 2009

(54) LOCATION-BASED PROFILE-ADJUSTING SYSTEM AND METHOD FOR ELECTRONIC DEVICE

(75) Inventors: Jason B. Yonker, Lee's Summit, MO (US); Charles L. Bartel, Overland Park, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town, KY (US)

(21) Appl. No.: 12/015,813

(22) Filed: Jan. 17, 2008

(51) Int. Cl. H04Q 7/20; H04M 1/00

(52) U.S. Cl. 455/456.6; 455/550.1

(57) ABSTRACT

An electronic device includes a communication element, a location-determining component, a computing device, and a display. The communication element receives and transmits communication. The location-determining component monitors the location of the electronic device. The computing device is coupled to the communication element and the location-determining component and can change at least one setting of the electronic device based on the location of the device.

### BACKGROUND OF THE INVENTION

Embodiments of the present invention relate to electronic devices, such as navigation devices and mobile phones. More particularly, the present invention relates to a location-based profile adjusting system and method for an electronic device.

Users often wish to change the settings or configuration of their electronic devices. For example, users often switch their mobile phones to a vibrate mode when in meetings, at a movie theatre and turn them off entirely when on an airplane or in a church. Unfortunately, users often forget to change such settings and therefore interrupt others with unexpected phone calls. Some electronic devices automatically change their settings or configuration based on certain events and actions or data from a variety of inputs. For example, some electronic devices change their settings based on the time of day or the time of year. Other devices change their settings based on their current environment, sensing characteristics such as ambient noise or ambient light. Still others change their settings based on the motion of the device, using data from motion detectors such as accelerometers. Unfortunately, these self-adjusting electronic devices often fail to change their settings when it is most appropriate or desirable for them to do so.

### SUMMARY OF THE INVENTION

Embodiments of the present invention provide a distinct advance in the art of self-adjusting electronic devices. More particularly, embodiments of the invention provide an electronic device that can automatically adjust its settings based on the current or expected location of the device.

In various embodiments, the electronic device may include a communication element, a location-determining component, a computing device, and a display. The communication element receives and transmits communications. The location-determining component monitors the location of the electronic device. The computing device is coupled to the communication element and the location-determining component, and can change at least one setting of the electronic device based on the location of the device. The display displays information to the user about the status of the electronic device.

In some embodiments, when the location-determining component determines that the current location of the electronic device matches one of a plurality of predetermined locations, the computing device changes at least one setting of the electronic device and may alert the user that it has done so. When the electronic device moves away from the predetermined location, the computing device returns the setting to its previous state, and may again alert the user that it has done so.

In other embodiments, when the location-determining component determines that the current location of the electronic device matches one of a plurality of predetermined locations, the computing device prompts the user to accept the change of at least one setting of the electronic device. If the user agrees, the change is made. When the electronic device moves away from the predetermined location, the computing device prompts the user to return any changed setting to its previous state. If the user agrees, the return is made.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an electronic device constructed in accordance with various embodiments of the present invention;

FIG. 2 is a block diagram showing the components of the electronic device;

FIG. 3 is a diagram of a Global Positioning System (GPS) that may be utilized by various embodiments of the present invention;

FIG. 4 shows a display of the electronic device depicting an alert to a user;

FIG. 5 shows the display of the electronic device depicting a prompt to the user;

FIG. 6 is a flow diagram depicting some of the steps performed in a method of using the electronic device; and

FIG. 7 is a flow diagram depicting some of the steps performed in another method of using the electronic device.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

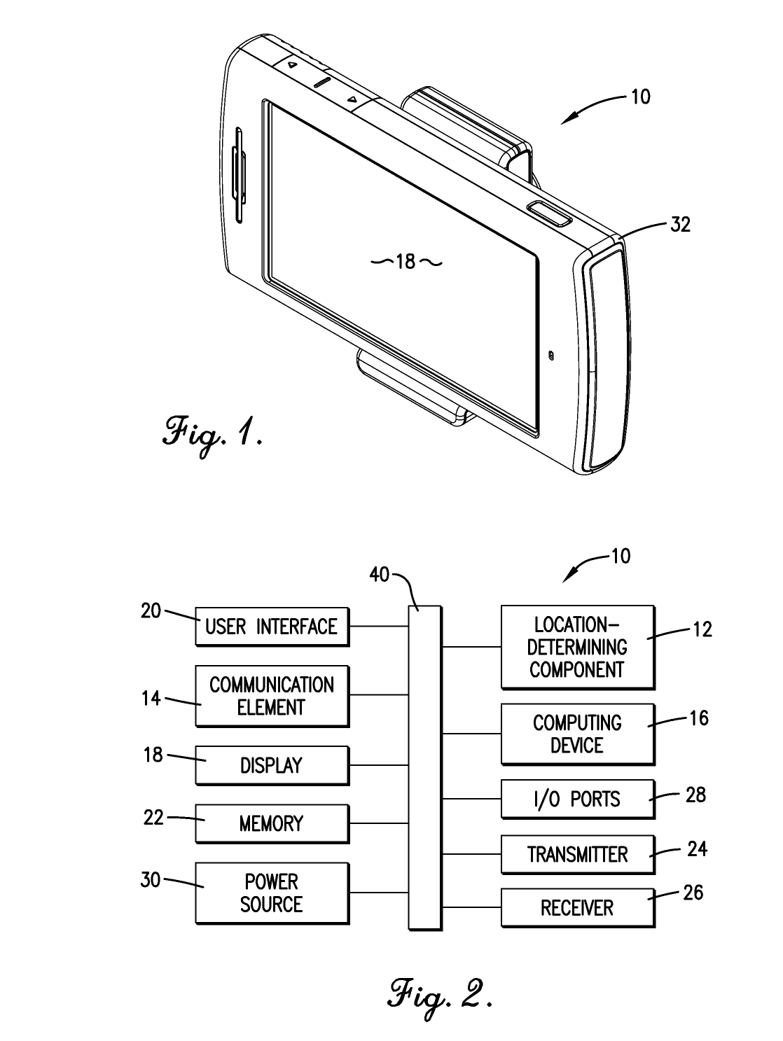

FIGS. 1 and 2 illustrate an electronic device 10 constructed in accordance with various embodiments of the present invention. The device 10 may be any electronic device operable to receive, utilize, or determine geographic information, such as a current geographic location. In certain embodiments, the electronic device 10 may be a mobile (e.g., cellular or cell) phone or navigation device manufactured by GARMIN INTERNATIONAL, INC. of Olathe, Kans. However, in general, the electronic device 10 may be any device configured as described herein or otherwise operable to perform the functions described below.

As seen primarily in FIG. 2, the electronic device 10 includes a location-determining element 12, a communication element 14, a computing device 16, a display 18, a user interface 20, a memory component 22, a transmitter 24, a receiver 26, I/O ports 28, and a power source 30. In various embodiments, these components are contained within a portable, hand-held housing 32.

In various embodiments, the location-determining element 12 may be a global positioning system (GPS) receiver which provides geographic location information for the electronic device 10. As an example, the location-determining element 12 may be a GPS receiver much like those provided in products by GARMIN INTERNATIONAL, INC.

In general, the GPS is a satellite-based radio navigation system capable of determining continuous position, velocity, time, and direction information for an unlimited number of users. Formally known as NAVSTAR (Navigation Signal Timing and Ranging), the GPS incorporates a plurality of satellites which orbit the earth in extremely precise orbits. Based on these precise orbits, GPS satellites can relay their location to any number or receiving units.

The GPS system is implemented when a device specially equipped to receive GPS data begins scanning radio frequencies for GPS satellite signals. Upon receiving a radio signal from a GPS satellite, the device can determine the precise location of that satellite via one of different conventional methods. The device will continue scanning for signals until it has acquired at least three different satellite signals. Implementing geometrical triangulation, the receiver utilizes the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS-enabled devices are often used to describe navigational devices, any receiver suitable for use with other global navigation satellite systems (GNSS) may be used instead of or in addition to the GPS receiver. It will also be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. In this way, personal hand held devices, mobile phones, intelligent appliances, intelligent apparel, and others can be readily located geographically, if appropriated equipped to be a receiving unit.

FIG. 3 shows one representative view of a GPS denoted generally by reference numeral 34. A plurality of satellites 36 are in orbit about the Earth 38. The orbit of each satellite is not necessarily synchronous with the orbits of other satellites and, in fact, is likely asynchronous. A GPS receiver device 10 such as the ones described in connection with preferred embodiments of the present invention is shown receiving spread spectrum GPS satellite signals from the various satellites 36.

The spread spectrum signals continuously transmitted from each satellite 36 utilize a highly accurate frequency standard accomplished with an extremely accurate atomic clock. Each satellite 36, as part of its data signal transmission, transmits a data stream indicative of that particular satellite. The electronic device 10 must acquire spread spectrum GPS satellite signals from at least three satellites for the GPS receiver device to calculate its two-dimensional position by triangulation. Acquisition of an additional signal, resulting in signals from a total of four satellites, permits the electronic device 10 to calculate its three-dimensional position.

In various embodiments, the location-determining component 12 and computing device 16 are operable to receive navigational signals from the GPS satellites 36 and to calculate positions of the device 10 as a function of the signals. The location-determining component 12 and computing device 16 may, for example, determine a track log or any other series of geographic coordinates corresponding to points along a path traveled by a user of the device. The location-determining component 12 and/or the computing device 16 are also operable to calculate a route to a desired location, provide instructions to navigate to the desired location, display maps and other information on the display screen 18, and to execute other functions described herein.

The location-determining component 12 may include one or more processors, controllers, or other computing devices and memory so that it may calculate location and other geographic information without the computing device 16 or it may utilize the components of the computing device 16. Further, the location-determining component 12 may be integral with the computing device 16 such that the location-determining component 12 may be operable to specifically perform the various functions described herein. Thus, the computing device 16 and location-determining component 12 can be combined or be separate or otherwise discrete elements.

In other embodiments, the location-determining component 12 need not directly determine the current geographic location of the electronic device 10. For instance, the location-determining component 12 may determine the current geographic location by receiving location information directly from the user, through a communications network, or from another electronic device.

The location-determining component 12 may include an antenna to assist in receiving the satellite signals. The antenna may be a patch antenna, a linear antenna, or any other type of antenna that can be used with navigational devices. The antenna may be mounted directly on or in the housing 32 or may be mounted external to the housing 32.

The communication element 14 enables the device 10 to communicate with other electronic devices or any other network enabled devices through a communications network, such as the Internet, a local area network, a wide area network, an ad hoc or peer to peer network, or a direct connection such as a USB, Firewire, or Bluetooth™ connection, or the like. Similarly, the device 10 may be configured to allow direct communication between similarly configured navigation devices, such that the device 10 need not necessarily utilize the communications network to share geographic location information.

In various embodiments, the communication element 14 may enable the device 10 to wirelessly communicate with a communications network utilizing wireless data transfer methods such as WiFi (802.11), Wi-Max, Bluetooth™, ultra-wideband, infrared, mobile telephony, radio frequency, or the like. However, the communication element 14 may couple with a communications network utilizing wired connections, such as an Ethernet cable, and is not limited to wireless methods.

In certain embodiments, the communication element 14 is a mobile transceiver for transmitting and receiving mobile phone calls over a mobile telephone network. The communication element 14 may include components normally associated with a mobile phone, such as a sound-producing element, like a speaker, transducer, or headset, and a vibration-producing component such as a motor coupled to an eccentric load. Further, the communication element 14 may include features and settings normally associated with a mobile phone, such as, but not limited to, a security lock mode, a personal data lock mode, ring tone, ringer volume, a vibration mode, an enable Wifi mode, an enable Bluetooth™ mode, a mode for automatically sending calls to voice mail, a mode for automatically forwarding calls, a roaming mode, and an airplane mode.

The computing device 16 may include any number of processors, controllers, integrated circuits, programmable logic devices, or other processing systems and resident or external memory for storing data and other information accessed and/or generated by the electronic device 10. The computing device 16 is coupled with the location-determining component 12, display 18, user interface 20, and memory 22, through wired or wireless connections, such as a data bus 40, to enable information to be exchanged between the various components.

The computing device 16 may implement a computer program which performs some of the functions described herein. In exemplary embodiments, the computer program comprises an ordered listing of executable instructions for implementing logical functions in the processing system. The computer program can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), a portable computer diskette, and a portable compact disk read-only memory (CDROM).

In various embodiments, the display 18 is coupled with the computing device 16 and is operable to display various prompts to the user as is described below. The display 18 may comprise color display elements (or alternatively, black and white or monochrome display elements) including, but not limited to, LCD (Liquid Crystal Diode), TFT (Thin Film Transistor) LCD, LEP (Light Emitting Polymer) or PLED (Polymer Light Emitting Diode), and/or plasma display devices. Preferably, the display 18 is of sufficient size to enable the user to easily view the display 18 to receive presented information while in transit.

The display 18 may also be used to provide prompts to the user that certain settings may be changed due to the location of the electronic device 10. The computing device 16 may control what is shown on the display 18 and may present a text box on the display 18 that alerts the user that a predetermined setting may be changed. The computing device 16 may also prompt the user to accept the change or reject it.

Further, as described above, the display 18 may be integrated with the user interface 20, such as in embodiments where the display 18 is a touch-screen display to enable the user to interact with the display 18 by touching or pointing at display areas to provide information to the electronic device 10.

The user interface 20 permits a user to operate the device 10 and enables users, third parties, or other devices to share information with the device 10. The user interface 20 is generally associated with the housing 32, such as by physical connection through wires, etc, or wirelessly utilizing conventional wireless protocols. Thus, the user interface 20 need not be physically coupled with the housing 32.

The user interface 20 may comprise one or more functional inputs such as buttons, switches, scroll wheels, a touch screen associated with the display, voice recognition elements such as a microphone, pointing devices such as mice, touchpads, trackballs, styluses, a camera such as a digital or film still or video camera, combinations thereof, or the like. Further, the user interface 20 may comprise wired or wireless data transfer elements such as removable memory including the memory 22, data transceivers, etc, to enable the user and other devices or parties to remotely interface with the device 10. The device 10 may also include a speaker for providing audible instructions and feedback.

The user interface 20 may be operable to provide various information to the user utilizing the display 18 or other visual or audio elements such as a speaker. Thus, the user interface 20 enables the user and electronic device 10 to exchange information relating to the device 10, including fuel station information, geographic entities, configuration, security information, preferences, route information, points of interests, alerts and alert notification, navigation information, waypoints, a destination address, or the like. The user interface 20 may also enable the user to accept or reject a change of a setting by pressing a button, key, or touch screen.

The memory 22 may be integral with the location-determining component 12, integral with the computing device 16, stand-alone memory, or a combination of both. The memory 22 may include, for example, removable and non-removable memory elements such as RAM, ROM, flash, magnetic, optical, USB memory devices, and/or other conventional memory elements.

The memory 22 may store various data associated with operation of the device 10, such as the computer program and code segments mentioned above, or other data for instructing the computing device 16 and other device elements to perform the steps described herein. Further, the memory 22 may store various cartographic data corresponding to geographic locations including map data, and map elements, such as thoroughfares, terrain, alert locations, points of interest, geographic entities, radio stations, and other navigation data to facilitate the various navigation functions provided by the device 10. Additionally, the memory 22 may store destination addresses and previously calculated or otherwise acquired routes to various destination addresses for later retrieval by the computing device 16.

The memory 22 or some other memory accessible by the computing device 16 may store a database of known paths including known roads, road networks, road segments, intersections, hiking trails, tracks, sidewalks or any other known paths for which the geographic coordinates are known. As used herein, “roads” is meant to include all navigable pathways including, but not limited to, highways, streets, boulevards, avenues, parkways, rural routes, terraces, and even private streets, driveways, and parking lots. The database of known paths may be pre-loaded in the memory 22 or other memory or may be downloaded to the device via the communication element 14, receiver 26, or I/O ports 28. For example, different databases of known paths may be downloaded to the device based on a current location of the device as determined by the location-determining component 12 or computing device 16.

In various embodiments, the memory 22 may also store the location of various landmarks and buildings, such as churches, theaters, hospitals, restaurants, bars, stadiums, shopping malls, schools, libraries, airports, etc., in addition to user-specified locations such as home or work.

The various data stored within the memory 22 may be associated within one or more databases to facilitate retrieval of the information. For example, the databases may be configured to enable the computing device 16 to automatically access the database of known paths based upon a current geographic location of the electronic device 10 as discussed in more detail below.

A map mapping search engine, preferably comprised of software, firmware or the like executed by the computing device 18, may search through the database of cartographic information to find known roads or other known paths which match a series of geographical coordinates. A user may initiate a search or the search engine may automatically search the database based on a state of the device 10 such as the current position of the device 10. The search engine, or alternatively a separate computation engine (also preferably comprised of software, firmware or the like executed by the computing device 18), may also perform calculations related to the cartographic information. The map mapping search engine may also identify a map location, such as a street address or intersection, associated with one or more geographical coordinates.

In various embodiments, the computing device 18, in combination with the location-determining device 12, may also determine when the electronic device 10 is within a range of any of the plurality of predetermined locations, known as a vicinity range. The vicinity range may be a distance, in meters or feet, in any direction from a predetermined location. Setting of the vicinity range may be factory-programmed or user-specified and the vicinity range may be different for different locations. The vicinity range may be included when the computing device 18 is determining whether the current location of the electronic device 10 matches a predetermined location. Thus, the computing device 18 may determine that the current location of the device matches a predetermined location when the device 10 is not at the precise coordinates of the predetermined location, but rather within the vicinity range of the coordinates of the location. For example, the vicinity range may be set to 100 feet. Hence, the computing device 18 may determine when the current location of the electronic device 10 is within 100 feet of a predetermined location and may take appropriate action such as changing one or more settings of the device 10. In other embodiments, the vicinity range may be as small as a few feet or as great as several miles.

Including the vicinity range when determining whether the current location of the electronic device 10 matches a predetermined location may be useful when the location prohibits the reception of a location-determining signal, such as GPS. The location may possess radiation shielding structures that weaken or attenuate the GPS signal. Or, there may be signal interference from other electronic transmitting or receiving devices. With such a location, it is advantageous for the computing device 18 to determine when the electronic device 10 is within the vicinity range of a predetermined location.

The transmitter 24 and receiver 26 or a transceiver assembly may be provided to enable wireless transmission of information. For example, in exemplary embodiments, the electronic device 10 includes a Frequency Modulated (FM) receiver for receiving information such as music, Radio Data system (RDS) information, FM Traffic Message Channel (TMC) information, direct band information such as MSN Direct™ data, or the like. Alternatively, or in addition, the transmitter 24 and receiver 26 assemblies may comprise a short range transmitter and receiver such as a Bluetooth™ receiver/transmitter assembly, a mobile telephone (e.g., TDMA (Time Division Multiple Access), CDMA (Code Division Multiple Access), GSM (Global System for Mobile Communication), etc.) receiver/transmitter assembly, or the like.

The I/O ports 28 permit data and other information to be transferred to and from the computing device 16 and the location-determining component 12. Navigational software, cartographic maps and other data and information may be loaded in the electronic device 10 via the communication element 14, the receiver 26, or the I/O ports 28.

The power source 30 is associated with the housing 32 to provide electrical power to various electronic device 10 elements. For example, the power source 30 may be directly or indirectly coupled with the location-determining component 12, computing device 16, display 18, user interface 20, and/or memory 22. The power source 30 may comprise conventional power supply elements, such as batteries, battery packs, or the like. The power source 30 may also comprise power conduits, connectors, and receptacles operable to receive batteries, battery connectors, or power cables. For example, the power source 30 may include both a battery to enable portable operation and a power input for receiving power from an external source such an automobile.

The housing 32 may be handheld or otherwise portable to facilitate easy transport of the device 10. In some embodiments, the housing 32 may be configured for mounting within or on an automobile or other vehicle in a generally conventional manner. The housing 32 may be constructed from a suitable lightweight and impact-resistant material such as, for example, plastic, nylon, aluminum, or any combination thereof. The housing 32 may include one or more appropriate gaskets or seals to make it substantially waterproof or resistant. The housing 32 may take any suitable shape for size, and the particular size, weight and configuration of the housing may be changed without departing from the scope of the present invention.

The components shown in FIGS. 1 and 2 and described herein need not be physically connected to one another since wireless communication among the various depicted components is permissible and intended to fall within the scope of the present invention.

In exemplary embodiments, the electronic device 10 may operate as follows. The electronic device 10 may include a default configuration prepared and programmed during manufacturing or assembly. The configuration may include widely used standard settings for common locations. For example, in those locations where silent operation is desirable, such as a church (or like place of worship), a library, a movie theatre, or a medical facility, automatically adjusted settings may include turning the ringer volume to low or off and enabling the vibration mode. Alternatively, in locations where there is already a lot of noise, such as a stadium, a store, or a shopping mall, settings that are automatically adjusted may include turning the ringer volume to high and turning the speaker or headset volume to high. In addition, the default configuration may include a setting for the vicinity range.

In certain embodiments, the user may customize the default configuration to create a device profile that suits his or her individual needs. The user may specify, through the user interface 20, which settings of the device 10 should be changed for various predetermined locations. For example, the settings to change when in or around a church may include turning the ringer volume to low or off and enabling the vibration mode. In addition, the user may specify what settings to change when not in a particular location. For example, when the user is not at home or at work, the security lock mode is automatically enabled. Alternatively, the user may specify, through the user interface 20, which locations should be associated with the changing of a setting. For example, the locations associated with turning the ringer volume to low or off and enabling the vibration mode may include churches, libraries, museums, schools, medical and dental facilities, etc. Furthermore, the user may specify the value of the vicinity range, and whether it should be the same for all locations or specified on a location basis. Typically, this type of customized setup is a one-time or only occasional activity.

Generally, the user may carry the electronic device 10 on his person as he moves around, such as walking, jogging, running, or hiking, or as he travels in a vehicle, such as an automobile or boat. Alternatively, the electronic device 10 may be attached or mounted to the vehicle as it is traveling. The location-determining component 12 monitors the current location of the device 10, as described above.

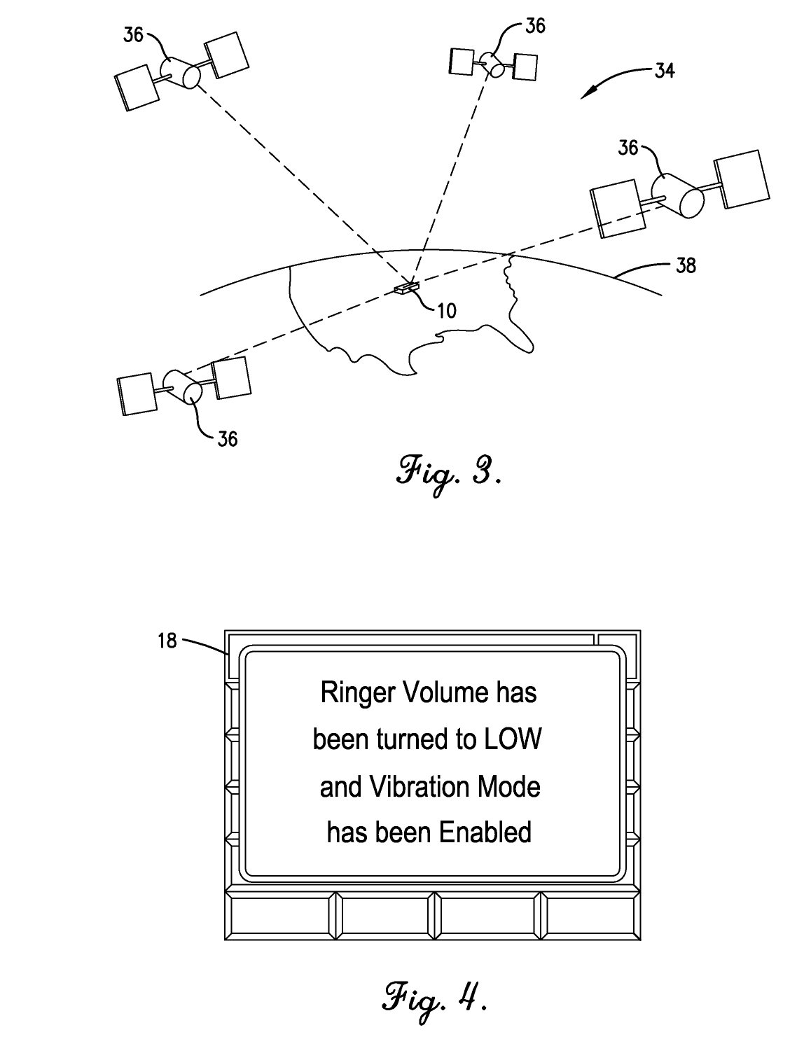

In some embodiments, once the location-determining component 12 detects that the current location is within vicinity range of one of the predetermined locations as discussed above, the computing device 16 automatically adjusts one or more settings for the electronic device 10. The computing device 16 may then momentarily show a message on the display 18 alerting the user that the one or more settings have been changed, as depicted in FIG. 4. The computing device 16 may also alert the user in other ways, such as by momentarily vibrating or issuing a brief audible message. When the electronic device 10 is again in motion and the location-determining component 12 senses that the current location is out of the vicinity range of the predetermined location, the computing device 16 can automatically return the one or more settings back to their previous states. The computing device 16 may then momentarily show a message on the display 18 alerting the user that the one or more settings have been returned to their previous states.

In one embodiment, when the location-determining component 12 detects that the current location matches the user-specified location for home, work, or other user-determined location, the computing device 16 may allow unrestricted usage of the electronic device 10, including the ability to change settings and access to such features as voice mail, email, and web browsing, such as disclosed in U.S. patent application Ser. No. 11/353,617 “ELECTRONIC DEVICE HAVING A LOCATION-BASED SECURITY FEATURE”, which is herein incorporated by reference in its entirety. The computing device 16 may also automatically set such parameters as the ringtone or the background image of the display 18. When the location-determining component 12 detects that the current location does not match home or work, the computing device 16 may change the settings to allow the ability to send and receive communications, such as phone calls or text messages, but may restrict the ability to change settings or access voice mail, email, and web browsing unless a password is entered. Settings such as the ringtone and the background image of the display 18 may be changed as well.

In another embodiment, when the location-determining component 12 detects that the current location is within the vicinity range of a location where mobile phone use is prohibited or discouraged, such as a church, a theater, or medical facility, the computing device 16 may automatically change the ringer volume to low or off, enable the vibration mode, and forward a call to voice mail after alerting the user that the call was received. When the location-determining component 12 detects that the current location is out of the vicinity range of a location where mobile phone use is prohibited or discouraged, the computing device 16 may automatically return any changed settings to their previous states.

In another embodiment, when the location-determining component 12 detects that the current location is within the vicinity range of a location where mobile phone use is allowed as long as it does not disturb others, such as a school, a library, or museum, the computing device 16 may automatically change the ringer volume to low or off and enable the vibration mode, while allowing the user to accept incoming phone calls. When the location-determining component 12 detects that the current location is no longer within the vicinity range of a location where mobile phone use is allowed as long as it does not disturb others, the computing device 16 may automatically return any changed settings to their previous states.

In another embodiment, when the location-determining component 12 detects that the current location is within the vicinity range of a location with high levels of ambient noise, such as a stadium, a restaurant, or a shopping mall, the computing device 16 may automatically change the ringer volume to high and the speaker or headset volume to high. When the location-determining component 12 detects that the current location is no longer within the vicinity range of a location with high levels of ambient noise, the computing device 16 may automatically return any changed settings to their previous states.

In another embodiment, when the location-determining component 12 detects that the current location is within the vicinity range of a location where mobile phone use is strictly prohibited, such as a boarding gate or jetway of an airport or within an airplane, the computing device 16 may automatically enable the airplane mode, which may include disabling the location-determining component 12. Thus, once the airplane mode is enabled, the user may manually disable airplane mode and restore the operation of the location-determining component 12.

In another embodiment, when the location-determining component 12 detects that the current location is greater than a certain distance from a city or metropolitan area, the computing device 16 may automatically enable the roaming mode. When the location-determining component 12 detects that the current location is within a certain distance from a city or metropolitan area, the computing device 16 may automatically return any changed settings to their previous states.

In another embodiment, when the location-determining component 12 detects that the current location is in an area known to have fewer cell towers, the computing device 16 may automatically power down the location-determining component 12 for longer periods of time in order to reduce power consumption of the electronic device 10. When the location-determining component 12 detects that the current location is in an area with a greater number of cell towers, the computing device 16 may automatically return any changed settings to their previous states.

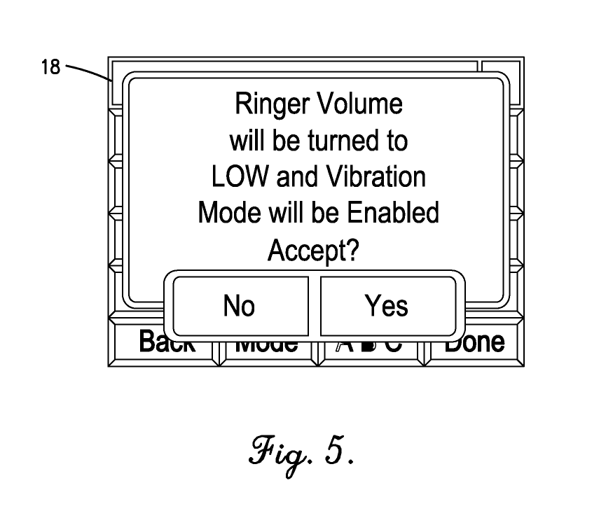

In other embodiments, once the current location is within the vicinity range of one of the predetermined locations, the computing device 16 shows a message on the display 18 that one or more settings may be changed. The computing device 16 may also alert the user by momentarily vibrating or issuing a brief audible message. The computing device 16 may also show a message on the display 18 prompting the user to accept or reject the changes, as depicted in FIG. 5. The user may enter his response utilizing the user interface 20. If the user accepts, the changes are made. If the user rejects the prompt, the changes are not made. When the electronic device 10 is again in motion and the location-determining component 12 senses that the current location is out of the vicinity range of the predetermined location, the computing device 16 shows a message on the display 18 that any changed setting may be returned to its previous state and prompts the user to accept or reject the change. The user may enter his response utilizing the user interface 20. If the user accepts, the change is made. If the user rejects the prompt, the change is not made.

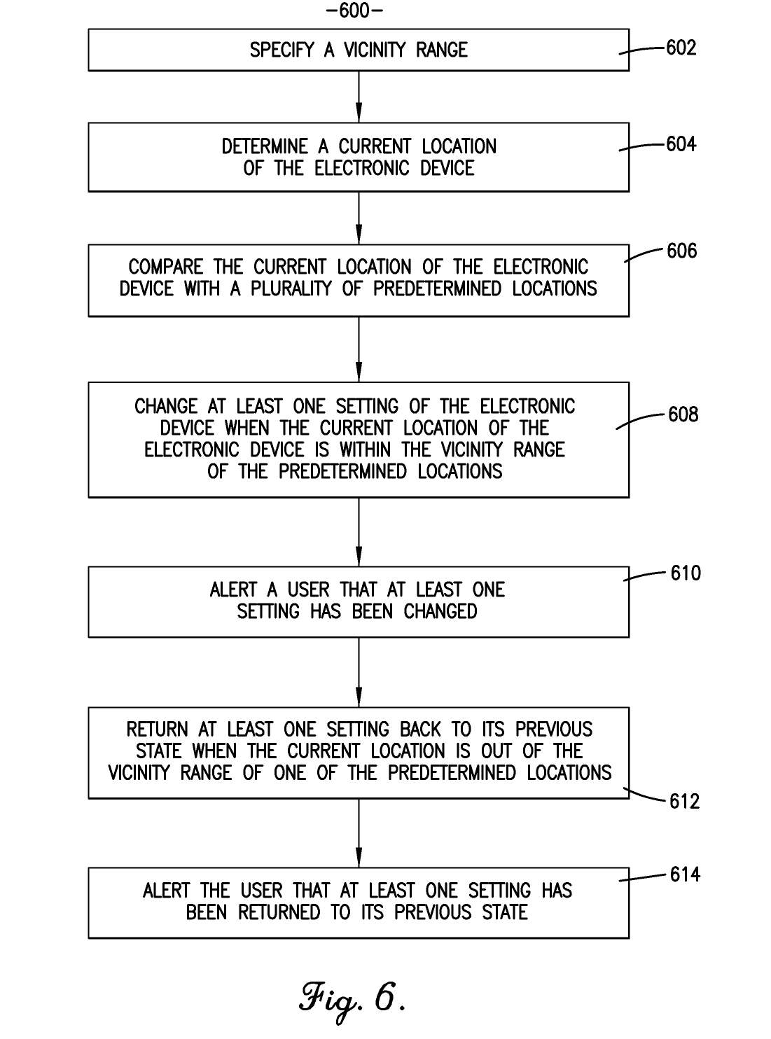

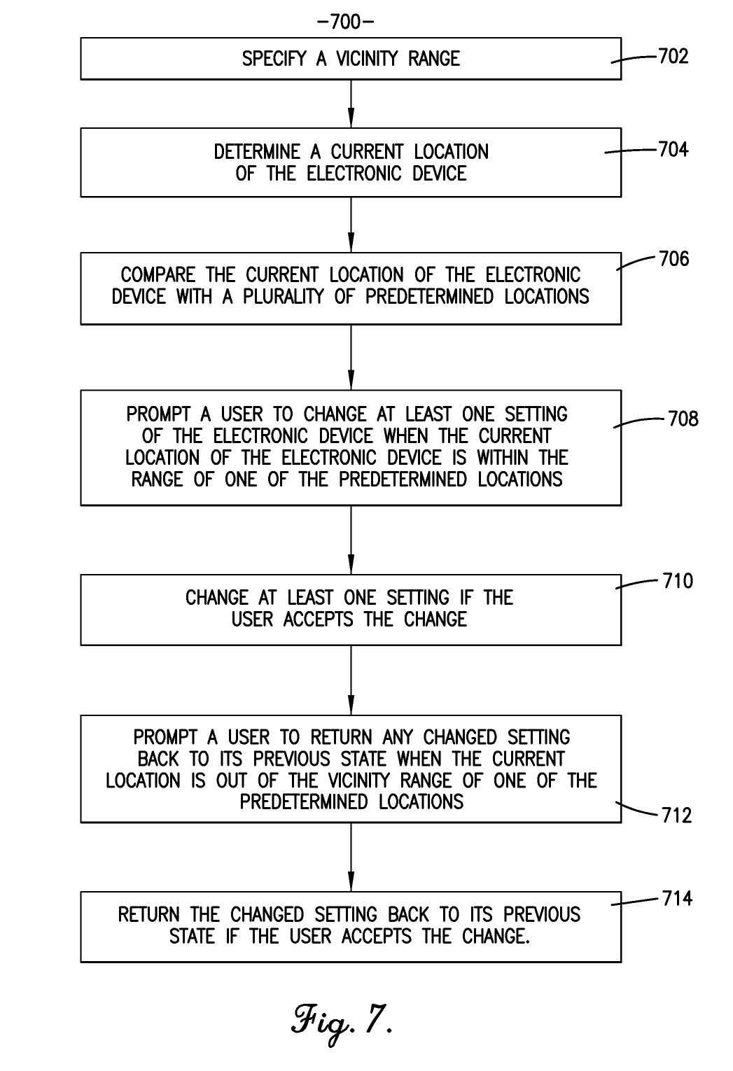

Methods of operating various embodiments of the electronic device 10 are also illustrated in FIGS. 6 and 7. The steps as shown in FIGS. 6 and 7 do not imply a particular order of execution. Some steps may be performed before or concurrently with other steps in contrast to what is shown in the figures. FIG. 6 shows a method 600 of operating the electronic device 10. Step 602 includes determining a current location of the electronic device 10. In one embodiment, the location-determining component 12 determines the current location of the electronic device 10. Step 604 includes comparing the current location of the electronic device 10 with a plurality of predetermined locations. In one embodiment, the computing device 16 compares the current location with the plurality of predetermined locations. Step 606 includes changing at least one setting of the electronic device 10 when the current location of the electronic device 10 matches one of the predetermined locations. In one embodiment, the computing device 16 changes at least one setting of the electronic device 10 when the current location of the electronic device 10 matches one of the predetermined locations. Step 608 includes alerting the user that at least one setting has been changed. In one embodiment, the computing device 16 alerts the user that at least one setting has been changed. Step 610 includes returning at least one setting back to its previous state when the current location does not match one of the predetermined locations. In one embodiment, the computing device 16 returns at least one setting back to its previous state when the current location does not match one of the predetermined locations. Step 612 includes alerting the user that at least one setting has been returned to its previous state. In one embodiment, the computing device 16 alerts the user that at least one setting has been returned to its previous state.

FIG. 7 illustrates another method 700 of operating the electronic device 10. Step 702 includes determining a current location of the electronic device 10. In one embodiment, the location-determining component 12 determines the current location of the electronic device 10. Step 704 includes comparing the current location of the electronic device 10 with a plurality of predetermined locations. In one embodiment, the computing device 16 compares the current location with the plurality of predetermined locations. Step 706 includes prompting a user to change at least one setting of the electronic device 10 when the current location of the electronic device 10 matches one of the predetermined locations. In one embodiment, the computing device 16 prompts a user to change at least one setting of the electronic device 10 when the current location of the electronic device 10 matches one of the predetermined locations. Step 708 includes changing at least one setting if the user accepts the change. In one embodiment, the computing device 16 changes at least one setting if the user accepts the change. Step 710 includes prompting a user to return any changed setting back to its previous state when the current location does not match one of the predetermined locations. In one embodiment, the computing device 16 prompts a user to return any changed setting back to its previous state when the current location does not match one of the predetermined locations. Step 712 includes returning the changed setting back to its previous state if the user accepts the change. In one embodiment, the computing device 16 returns the changed setting back to its previous state if the user accepts the change.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A handheld mobile communication device comprising:
a communication element for receiving and transmitting communications;
a location-determining component for monitoring locations of the handheld mobile communication device; and
a computing device, coupled to the communication element and the location-determining component, for changing at least one communications-related setting of the handheld mobile communication device based on a location of the handheld mobile communication device.

2. The handheld mobile communication device of claim 1, further comprising a display for displaying information to a user about a status of the handheld mobile communication device.

3. The handheld mobile communication device of claim 2, wherein the information includes an alert that at least one setting has been changed.

4. The handheld mobile communication device of claim 2, wherein the information includes a prompt to a user to change at least one setting.

5. The handheld mobile communication device of claim 1, wherein the communication element is selected from the group consisting of a radio transceiver; a Bluetooth™ transceiver; and a cellular transceiver for transmitting and receiving mobile phone calls over a cellular telephone network.

6. The handheld mobile communication device of claim 1, wherein the setting includes a ring tone.

7. The handheld mobile communication device of claim 1, wherein the setting includes a ringer volume.

8. The handheld mobile communication device of claim 1, wherein the setting includes a vibration mode.

9. The handheld mobile communication device of claim 1, wherein the setting includes an enable Wifi mode.

10. The handheld mobile communication device of claim 1, wherein the setting includes an enable Bluetooth™ mode.

11. The handheld mobile communication device of claim 1, wherein the setting includes a mode for automatically sending calls to voice mail.

12. The handheld mobile communication device of claim 1, wherein the setting includes an airplane mode.

13. The handheld mobile communication device of claim 1, wherein the setting includes a mode for automatically forwarding calls.

14. A method for changing a setting of a handheld mobile communication device comprising:
a) determining a current location of the handheld mobile communication device;
b) comparing the current location of the handheld mobile communication device with a plurality of predetermined locations; and
c) changing at least one communications-related setting of the handheld mobile communication device when the current location is within a range of one of the predetermined locations.

15. The method of claim 14, further comprising the step of specifying the value of the range.

16. The method of claim 14, further comprising the step of alerting a user that at least one setting has been changed.

17. The method of claim 14, further comprising the step of returning at least one setting back to its previous state when the current location is out of the range of one of the predetermined locations.

18. The method of claim 17, further comprising the step of alerting a user that at least one setting has been returned to its previous state.

19. The method of claim 14, wherein determining the current location of the handheld mobile communication device is accomplished by a GPS receiver which receives GPS signals from a plurality of GPS satellites and determines the locations of the handheld mobile communication device as a function of the received signals.

20. A method for changing a setting of a handheld mobile communication device comprising
a) determining a current location of the handheld mobile communication device;
b) comparing the current location of the handheld mobile communication device with a plurality of predetermined locations;
c) prompting a user to change at least one setting of the handheld mobile communication device when the current location is within a range of one of the predetermined locations; and
d) changing at least one communications-related setting if the user accepts the change.

21. The method of claim 20, further comprising the step of specifying the value of the range.

22. The method of claim 20, further comprising the step of prompting a user to return any changed setting to its previous state when the current location is out of the range of one of the predetermined locations.

23. The method of claim 22, further comprising the step of returning at least one setting back to its previous state if the user accepts the change.

24. The method of claim 20, wherein determining the current location of the handheld mobile communication device is accomplished by a GPS receiver which receives GPS signals from a plurality of GPS satellites and determines the locations of the handheld mobile communication device as a function of the received signals.
